(19) United States
(12) Patent Application Publication
(10) Pub. No.: US 2011/0114055 A1
(43) Pub. Date: May 19, 2011

(54) Method for operating a combustion engine

(75) Inventors: Claus Naegele, Stuttgart (DE); Mark Reichler, Remshalden (DE); Karsten Schmidt, Fellbach (DE); Isgard Sabelberg, Stuttgart (DE)

(73) Assignee: Andreas Stihl AG & Co. KG.

(21) Appl. No.: 12/926,385

(22) Filed: Nov. 15, 2010

(30) Foreign Application Priority Data
Nov. 16, 2009 (DE) 10 2009 053 047.9

(51) Int. Cl. F02D 17/04

(52) U.S. Cl. 123/198 DB

(57) ABSTRACT

A combustion engine (1) has a carburetor (17) for supplying an air/fuel mixture. An intake channel (16) is formed in the carburetor (17) and fuel is drawn into the intake channel because of the underpressure which forms during operation. The fuel quantity, which is drawn into the intake channel (16), is controlled at least in part by an electromagnetic fuel valve (23) which is open when no power is applied thereto. The engine (1) has a device for igniting the air/fuel mixture in the combustion chamber (3) of the engine and a stop switch (74) for switching off the ignition. Furthermore, a control unit (20) and a device (75) for energy supply are provided. A method for operating the engine (1) provides that the fuel valve (23) is held in the closed position by the control unit (20) after the stop switch (74) is actuated.

### CROSS REFERENCE TO RELATED APPLICATION

This application claims priority of German patent application no. 10 2009 053 047.9, filed Nov. 16, 2009, the entire content of which is incorporated herein by reference.

### FIELD OF THE INVENTION

The invention relates to a method for operating a combustion engine.

### BACKGROUND OF THE INVENTION

U.S. Pat. No. 7,126,449 discloses an electromagnetic valve which is open when no power is present. This valve can be used to supply fuel to a combustion engine.

U.S. Pat. No. 6,932,058 discloses a carburetor array for a combustion engine which uses a switchable valve to control the amount of fuel supplied to the intake channel. It has turned out that using a valve which is open when no power is present to control the amount of fuel supplied can make restarting the combustion engine more difficult.

### SUMMARY OF THE INVENTION

It is an object of the invention to provide a method for operating a combustion engine wherein the combustion engine has a simple configuration and can be started easily.

The method of the invention is for operating a combustion engine. The combustion engine includes: a combustion chamber; a carburetor for supplying an air/fuel mixture and the carburetor having an intake channel formed therein wherein, during operation of the combustion engine, an underpressure develops drawing fuel into the intake channel; an electromagnetic fuel valve configured to be open when unpowered and to at least partially control the amount of fuel supplied to the intake channel; an ignition device for igniting the air/fuel mixture in the combustion chamber; a stop switch for switching off the ignition device; a control unit; and, an energy supply device. The method includes the steps of: actuating the stop switch; and, then causing the control unit to hold the fuel valve closed.

In known combustion engines, the energy supply to the fuel valve is interrupted when the ignition is turned off via the stop switch. Utilizing a fuel valve which is open when no power is supplied causes the fuel valve to open again because it is not supplied with power. Since the crankshaft still rotates after the ignition is short circuited, underpressure is still generated in the intake channel which results in more fuel being drawn in. To avoid this, it was proposed that the valve which is open and unpowered after closing the stop switch, that is after shutting off the combustion engine, be further actively powered and thereby kept closed.

Such combustion engines can be used in handheld work apparatus such as a motor-driven chain saws, cutoff machines, brushcutters, lawnmowers or the like. These work apparatus are to have a weight as low as possible. That is why usually no permanent energy storage such as a battery, a rechargeable battery or the like is provided. In order to keep the valve closed for as long as possible after closing the stop switch, the available energy must be used as efficiently as possible. For this purpose, the fuel valve is only kept closed when there is underpressure in the intake channel. If the intake channel is closed in the direction of the crankcase, for example, via the piston skirt, no active closing of the fuel valve is necessary, since there exists no considerable underpressure when the intake channel is closed and therefore no fuel is drawn into the intake channel even if the fuel valve is open.

In order to ensure that the valve closes quickly and securely while in operation, the fuel valve is closed with a current peak and is kept closed at a low current level. Thus, a very fast closing of the valve can be achieved. By lowering the energy level after closing, energy can be saved. After closing the stop switch, closing the fuel valve and/or keeping the fuel valve closed is achieved at a lower current level than during operation. Thereby, the energy needed to close or keep closed is reduced. Since the underpressure generated after the closing of the stop switch is lower than during operation, for example, at full load, and small amounts of drawn-in fuel are acceptable after the closing of the stop switch, sufficiently fast closing of the fuel valve with noticeably less energy consumption can be achieved. Thereby, it can especially be provided that, after the closing of the stop switch, the current peak to close the fuel valve is lower than during operation. The power used to keep the valve closed, however, corresponds to that used during operation.

Advantageously, the fuel valve is kept closed at the low current level for more than one rotation of the crankshaft of the combustion engine during operation or after closing the stop switch. Because the fuel valve is kept closed for more than one rotation of the crankshaft of the combustion engine, the current peak for a renewed closing of the fuel valve can be omitted. Thereby, energy during operation and after closing of the stop switch, that is after shutting off the machine, can be saved. Keeping the fuel valve closed for more than one rotation of a crankshaft of the combustion engine at a low current level represents a separate inventive idea which is independent of keeping the fuel valve closed after closing the stop switch.

Advantageously, the combustion engine includes an energy store for the intermediate storage of energy. The energy store especially includes at least one capacitor. The capacitance of the capacitor in particular corresponds to the amount of energy required to keep the fuel valve closed after actuation of the stop switch. Advantageously, energy is stored in the energy store during operation. In particular, energy is additionally or alternatively stored in the energy store after the stop switch has been closed. The energy generated after shutting off the combustion engine can be obtained, for instance, from the further rotations of the crankshaft. For this, a corresponding wiring of the charging coils is required. Even if the energy of the crankshaft no longer suffices to move beyond the top dead center of the piston, it is possible to use the energy induced in a coil by the roll back of the crankshaft. In this connection, the control unit simultaneously recognizes reversing the direction of rotation of the crankshaft.

Advantageously, after the closing of the stop switch, the charging voltage of the energy store is monitored and the valve is no longer closed when the charging voltage falls below a minimum voltage. Thereby, any uncontrolled valve activity can be avoided. At the same time, a complete draining of the energy store is avoided.

Advantageously, the control unit has a microcontroller. In order to achieve an energy consumption of the microcontroller which is as low as possible, it is provided that the clock rate of the microcontroller changes in dependence on the operating state. Thereby, it is advantageous to select a clock rate which is invariably as low as possible. After closing of the stop switch, the microcontroller is operated at a low clock rate, so that the energy consumption can be further reduced.

Advantageously, the combustion engine rotatably drives a crankshaft, and the energy for ignition, controlling and closing the valve is generated by the rotational movement of the crankshaft. In particular, the energy to load the energy store is induced in a charging coil. In order to generate a comparatively large amount of energy at varying revolutions per minute, in particular also at low revolutions per minute, the charging coil has multiple sections from which subvoltages can be tapped. The energy induced in the charging coil is dependent on the revolutions per minute. At mid-range revolutions per minute there is a performance peak. At higher or lower revolutions per minute, the performance is reduced significantly. By appropriately wiring the section charging coils, a comparatively large amount of energy can be generated even at low revolutions per minute.

In particular, the energy is generated in a generator. In order to use the induced energy well, it is provided that the half-waves of the generator voltage generated are distributed to the consumers during operation. Advantageously, distribution takes place in dependence on the revolutions per minute, the amount of fuel supplied and the charge level of the energy store(s). Advantageously, the energy distribution takes place on a demand basis. Thus, a different distribution of the half-waves can be provided for different revolutions per minute or different operating conditions.

### BRIEF DESCRIPTION OF THE DRAWINGS

The invention will now be described with reference to the drawings wherein:

FIG. 1 is a schematic view of a combustion engine;

FIG. 2 is a schematic view of an embodiment of the arrangement to generate energy for the combustion engine of FIG. 1;

FIGS. 3a to 3d are schematic views of respective embodiments of the charging coil of FIG. 2;

FIG. 4 is a schematic of the carburetor of the combustion engine of FIG. 1;

FIG. 5 is a section view of the fuel valve of the carburetor of FIG. 4;

FIG. 6 shows the respective courses of the valve current, crankcase pressure and voltage of the energy store as a function of crankshaft angle;

FIG. 7 is a diagram of the voltage curve of the generator of FIG. 1;

FIG. 8 is a schematic side view of a motor-driven chain saw; and,

FIGS. 9 to 11 are respective schematic views of embodiments of the course of the valve current.

### DESCRIPTION OF THE PREFERRED EMBODIMENTS OF THE INVENTION

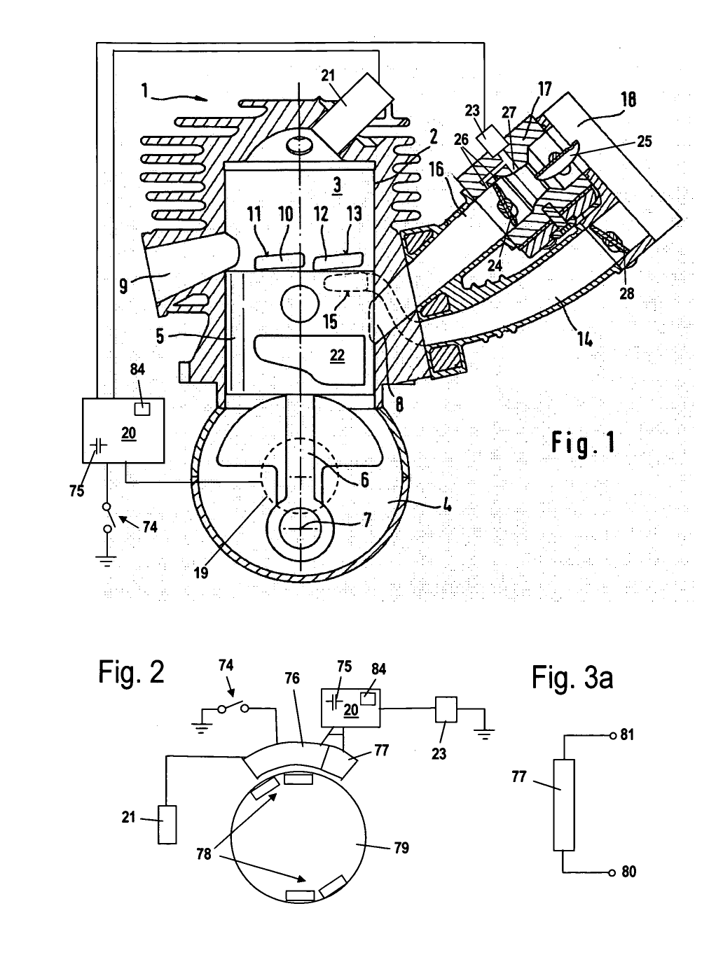

FIG. 1 shows a mixture-lubricated two-stroke engine operating with advance scavenging air as an embodiment of a combustion engine 1. The combustion engine 1 can be used as a drive motor in a handheld work apparatus such as a motor-driven chain saw, a cutoff machine, a brushcutter, a lawnmower or the like. The combustion engine 1 is a high-speed single-cylinder engine. The combustion engine 1 has a cylinder 2 in which a combustion chamber 3 is formed. The combustion chamber 3 is delimited by a reciprocating piston 5 mounted in the cylinder 2. The piston 5 rotatably drives a crankshaft 7 rotatably mounted in a crankcase 4 via a connecting rod 6. Air/fuel mixture is supplied to the crankcase 4 via an intake channel 16. The intake channel 16 opens with an inlet 8 into the crankcase 4, which is slot-controlled by the piston 5. An air channel 14 is provided for advance scavenging. In the area of the top dead center of the piston 5, the air channel 14 is connected to the transfer windows (11, 13) of the transfer channels (10, 12) via a piston pocket 22. The air channel 14 opens with an air channel opening 15 at the cylinder bore. The transfer channels (10, 12) connect the crankcase 4 to the combustion chamber 3 in the area of the bottom dead center of the piston 5. An outlet 9 for exhaust gases leads out of the combustion chamber 3.

The air channel 14 and the intake channel 16 are connected to an air filter 18. A section of the intake channel 16 is formed in the carburetor 17, in which fuel is supplied to the drawn-in combustion air. A choke flap 25 and downstream of the choke flap 25, a throttle flap 24 are pivotally mounted in the carburetor 17. Upstream of the throttle flap 24, a main fuel opening 27 opens into the intake channel 16. In the area of the throttle flap 24, secondary fuel openings 26 open into the intake channel 16. The amount of fuel supplied by the fuel openings (26, 27) is controlled by a fuel valve 23. The fuel valve 23 is an electromagnetic valve and is connected to a control unit 20 which supplies the fuel valve 23 with energy. To control the amount of fuel supplied, the fuel valve is controlled in a clocked manner. An air flap 28 is pivotally mounted in the air channel 14 to control the amount of air supplied.

A generator 19, which serves to supply energy, is arranged on the crankshaft 7. The generator 19 supplies the energy induced in the generator 19 on the basis of the rotational movement of crankshaft 7 to the control unit 20. The control unit 20 includes an energy store 75 which, for example, can include one or several capacitors. Furthermore, the control unit 20 includes a microcontroller 84. The control unit 20 is connected to a stop switch 74. Furthermore, the control unit 20 is connected to a spark plug 21 which projects into the combustion chamber 3 and serves to ignite the mixture in the combustion chamber 3.

During operation, air/fuel mixture is drawn into the crankcase 4 from the intake channel 16 during the upward stroke of the piston 5. In the area of the top dead center, mainly fuel-free combustion air is pre-stored in the transfer channels (10, 12) simultaneously via the air channel 14 and the piston pocket 22. During the downward stroke of the piston 5, the pre-stored advance scavenging air first flows out of the transfer channels (10, 12) and into the combustion chamber 3 and flushes the exhaust gases out of the combustion chamber 3 through the outlet 9. Subsequently, fresh air/fuel mixture flows out of the crankcase 4 and into the combustion chamber 3 via the transfer channels (10, 12). During the up-stroke of the piston 5, the mixture in the combustion chamber 3 is compressed and is ignited in the area of the bottom dead center by the spark plug 21. During the downward stroke of the piston 5, the exhaust gases exit the combustion chamber 3 as soon as the outlet 9 is opened by the downward moving piston. As soon as the transfer windows (11, 13) open, fresh advance scavenging air and fresh mixture flow into the combustion chamber.

The energy induced in the generator 19 serves to supply energy to the control unit 20 with the microcontroller 84 and to the fuel valve 23 and it serves to provide ignition energy for the spark plug 21. As FIG. 1 shows, the stop switch 74 is separately connected to the control unit 20 and is not arranged between the control unit 20 and the fuel valve 23 in the connecting cable. Thus, the fuel valve 23 can be controlled independently of the actuation of the stop switch 74.

FIG. 2 shows an embodiment in which the energy is not induced in a generator 19 but rather in an ignition coil 76 and a charging coil 77. The coils (76, 77) are arranged on the periphery of a fly wheel 79 which is fixedly connected to the crankshaft 7 so as to rotate therewith and which, in the embodiment, carries two magnet groups 78 to induce a voltage in coils (76, 77). One or several magnet groups 78 can be provided. The spark plug 21 is provided with energy via the ignition coil 76. The ignition coil 76 is further connected to the stop switch 74 via which the ignition coil 76 is grounded to thereby prevent the formation of ignition sparks at the spark plug 21. The charging coil 77 is connected to the control unit 20 which includes the energy store 75 and the microcontroller 84. The fuel valve 23 is controlled via the control unit 20. Even the point in time at which the ignition spark is generated can be controlled by the control unit 20. The control unit 20 is further connected to the stop switch 74 in such a manner that a closing of the stop switch 74 can be recognized by the control unit 20 and the fuel valve 23 can be controlled accordingly.

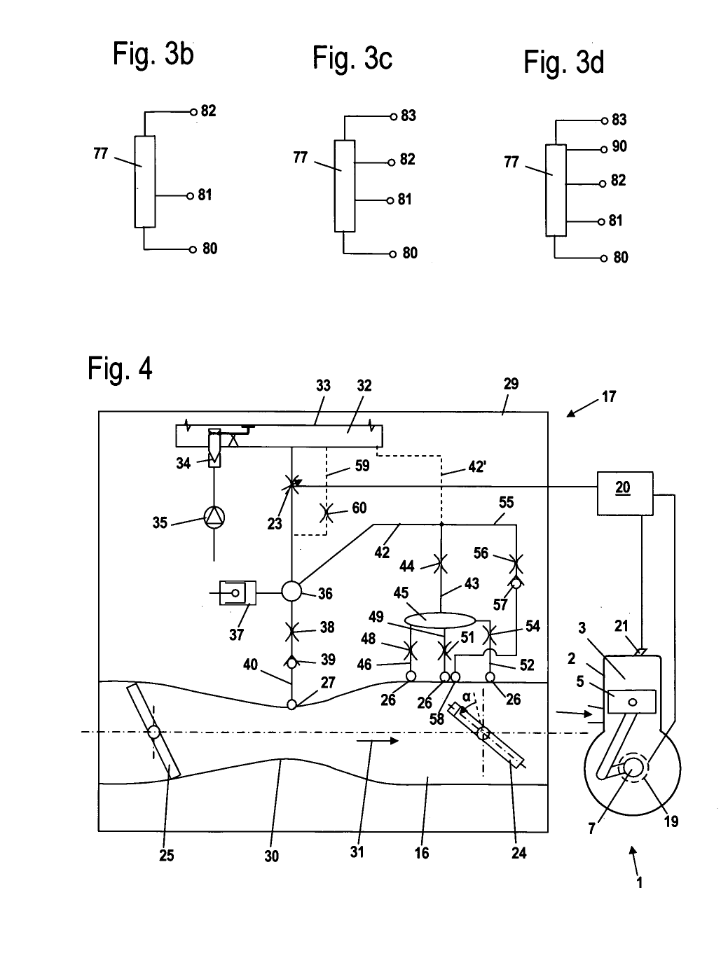

The energy induced in the coils (76, 77) is strongly dependent on the revolutions per minute of the crankshaft 7. In order to have a sufficient amount of energy available even at low revolutions per minute, it is provided that the charging coil 77 has multiple connectors (80, 81, 82, 83, 90) which tap different sections of the charging coil 77 and thereby make the tapping of sub-voltages possible. The number of connectors (80, 81, 82, 83, 90) of the charging coil 77 is variable and the charging coil 77 can contain one or more sections as shown by way of examples in FIGS. 3a to 3d. The sections of the charging coil 77 are advantageously wired to achieve an adaptation of the effective coil lengths to different revolutions per minute. Thereby, it is possible to provide energy having the appropriate voltage level to charge the energy store 75 at all revolutions per minute. A corresponding circuit arrangement can also be provided at the generator 19.

FIG. 4 schematically shows the carburetor 17 in detail. The carburetor 17 has a carburetor housing 29 in which a section of the intake channel 16 is formed. Combustion air in the intake channel 16 flows in flow direction 31. As FIG. 4 shows, a venturi 30, in whose area the main fuel opening 27 opens, is disposed between the choke flap 25 and the throttle flap 24 in flow direction. In the area of the throttle flap 24, the secondary fuel openings 26 open into the intake channel 16, which are configured as idling fuel openings. Additionally, a partial load fuel opening 58 is provided.

The carburetor 17 has a regulating chamber 32 which is delimited by a regulating membrane 33. The regulating membrane 33 can be charged by the surrounding air or from the air on the clean side of the air filter 18. An inlet valve 34, whose position is coupled to the position of the regulating membrane, is arranged at the inlet of the regulating chamber 32. The inlet valve 34 is supplied with fuel via a fuel pump 35. A main fuel path 40, in which the fuel valve 23 is arranged, leads out of the regulating chamber 23. A bypass channel 59 with a throttle 60 can be provided. The bypass channel 59 is shown in broken lines in FIG. 4 and bypasses the fuel valve 23. An annular gap 36, at which a purger 37 opens, is formed in the main fuel path 40. A throttle 38 and a check valve 39 are arranged in the main fuel path 40.

A secondary fuel path 42 branches off at the annular gap 36. The secondary fuel path 42′ can also be directly connected to the regulating chamber 32, so that the secondary fuel path 42′ is not controlled by the fuel valve 23. Thereby, no complete shutting off of the fuel supply is possible after shutting off the combustion engine 1. However, the amount of fuel supplied via the secondary fuel path 42′ is comparatively small.

The secondary fuel path 42 splits into an idling fuel path 43 and a partial load fuel path 55. The idling fuel path 43 opens via a throttle 44 into an idling fuel chamber 45 from which fuel paths 46, 49, and 52 branch off. A throttle (48, 51, 54) is arranged in each fuel path 46, 49, and 52. The idling fuel paths (46, 49, 52) open into the intake channel 16 via the secondary fuel openings 26. The partial-load fuel path 55, which comprises a throttle 56 and a check valve 57, opens into the intake channel 16 via the partial load fuel opening 58.

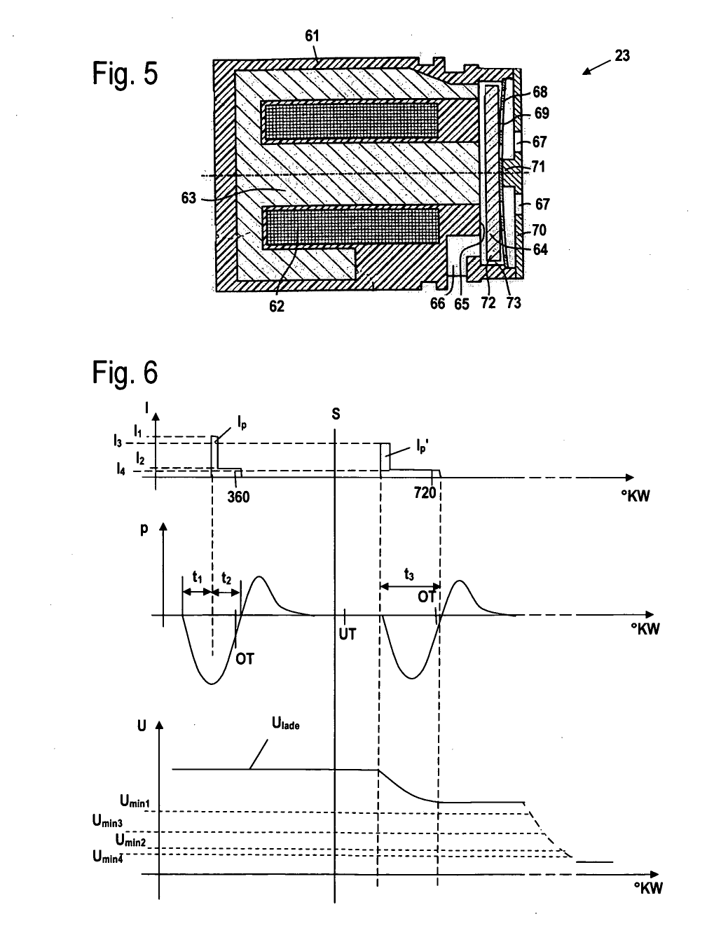

The fuel valve 23 is open in the unpowered state. The fuel valve 23 is shown in FIG. 5. The fuel valve 23 has a housing 61 in which a coil 62 is arranged. The coil 62 is surrounded by a pot-like shaped iron core 63. An armature plate 64 is arranged on the front of the coil 62. The coil 62 and the iron core 63 are advantageously molded into the material of the housing 61. The armature plate 64 is mounted on a spring 68 which pulls the armature plate 64 away from the coil. To define the fully open position of the fuel valve 23, which is shown in FIG. 5, a stop 71 is provided for the spring 68.

The fuel valve 23 has at least one fuel inlet 66, which opens at the side of the armature plate 64 facing the coil 62. When current is flowing in the coil 62, the fuel valve is closed by the armature plate 64, which is pulled against the front 65 of the iron core 63 when current is flowing. In the open state of the fuel valve 23, that is, when little or no current is flowing in the coil 62 to pull the armature plate 64 onto the front side 65, a gap, via which the fuel inlet 66 is connected to fuel outlets 67 formed in a cover 70, is formed between the edge 72 of the armature plate 64 and the housing 61. For this, the spring 68 has passthrough openings 69. Thus, fuel can flow from fuel inlet 66 through the fuel valve 23 to the fuel outlet 67 when no current is flowing in the coil 62. Instead of or in addition to the gap 73, openings in the armature plate 64 can be provided so that fuel can pass through.

The fuel valve 23 is advantageously controlled by the control unit 20 in a clocked manner to provide a desired amount of fuel. In this connection, it is provided that the fuel valve 23 is only powered when there is underpressure in the intake channel 16, that is, when the intake channel is open toward the crankcase. This is shown schematically in FIG. 6. However, other predetermined time periods can be provided during which the fuel valve 23 is kept closed. The first diagram in FIG. 6 shows the flow of current I in the electromagnetic fuel valve 23. The second diagram shows the course of the pressure p in the intake channel 16 and the third diagram shows the voltage U in the energy store 75. In the area of the bottom dead center UT, the intake channel 16 is closed toward the crankcase 4. There is no underpressure. During the up-stroke of the piston, underpressure builds up. In the second diagram, this is illustrated by the falling pressure curve. In the embodiment according to FIG. 6, first of all fuel is to be supplied, in particular, over a time period t₁. During this time, the fuel valve 23 is not powered so that fuel can be drawn into the intake channel 16 via the fuel valve 23 due to the underpressure in the intake channel 16. To control the amount of fuel drawn in, a clocked closing of the fuel valve 23 can be provided during the time period t₁.

Subsequently, the fuel valve 23 is closed for a time period t₂ during which no fuel is supplied but during which there is underpressure in the intake channel 16. As FIG. 6 shows, the fuel valve 23 is first powered with a current peak Iₚ, that is, with a current I₁. Thereafter the current level is lowered to a current level I₂ which is significantly lower and, for example, is a fraction of the current I₂. Due to the current peak Iₚ, a secure closing of the fuel valve 23 is achieved. The current I₂ is sufficient to keep the fuel valve 23 closed. Then, the pressure in the intake channel 16 increases so that there no longer exists an underpressure in the intake channel 16 and the fuel valve no longer needs to be actively closed. The fuel valve 23 is no longer powered. The energy storage 75 is fully charged with a charge voltage U_{LADE}, since the combustion engine 1 is running and sufficient energy is available.

At time S, the stop switch 74 is closed in the embodiment. Thereafter, no further fuel or only small amounts of fuel, for example, via the secondary fuel path 42′, are supplied. For this reason, it is provided that the control unit 20 continues to actively power the fuel valve 23 and keeps it closed. For this purpose, the fuel valve 23 is kept closed during time period t₃, during which there is underpressure in the intake channel 16 because of further rotations of the crankshaft 7. For this purpose, the fuel valve 23 is powered via a current peak I_{p′} by a current I₃ which is less than current I₁ of the current peak Iₚ but greater than current I₂. To keep the fuel valve 23 closed, the current drops to a current level I₄ which can correspond to the current level I₂ or can be lower than current level I₂. It can also be provided that current peak Iₚ, corresponds to current peak Iₚ. Because of the powering of the fuel valve 23, the charge voltage U_{lade} of the energy store sinks.

The drop in the charge voltage U_{lade} can be reduced if the energy generated by the rotational movement of the crankshaft 7 is used to further charge the energy store 75. At the same time, the clock rate of the microcontroller 84 can be reduced to a level as low as possible to reduce the energy consumption of the microcontroller 84. Correspondingly, the fuel valve 23 is powered by current I₄ for the subsequent crankshaft rotations over the time period t₃. During the coasting of the crankshaft 7, the charge voltage U_{lade} of the energy store 75 is continuously monitored. As soon as the charge voltage U_{lade} drops below minimum voltage Uₘᵢₙ, no further closing of the fuel valve 23 takes place. The minimum voltage Uₘᵢₙ can thereby be the voltage which suffices to keep the fuel valve 23 closed. Thus, no more powering of the fuel valve 23 takes place if the charge voltage minimum voltage U_{lade} drops below a corresponding minimum voltage Uₘᵢₙ. In this connection, a minimum voltage Uₘᵢₙ₂ can be used which is the minimum voltage required to power the fuel valve 23 with current I₂. Alternatively a minimum voltage Uₘᵢₙ₄ can be used, which is required to power the fuel valve 23 with current I₄.

In particular, additionally or alternatively it is provided that a closing of the fuel valve 23 will take place only if the energy in the energy store 75 is sufficient to achieve a secure switching of the fuel valve 23. If the energy is no longer sufficient, that is, if the charge voltage U_{lade} has dropped below a minimum voltage Uₘᵢₙ₁ or Uₘᵢₙ₃, no further powering of the fuel valve 23 will take place. The minimum voltage Uₘᵢₙ₁ is thereby required for the current level I₁ for the current peak Iₚ and the minimum voltage Uₘᵢₙ₃ is required for the current level I₃ and the current peak I_{p′}.

It can also be provided that the energy store 75 is charged only upon actuation of the stop switch 74, that is, when the combustion engine 1 is shut off and whenever all of the energy generated is used to operate the microcontroller 84 and to close the fuel valve 23.

In order to have as little energy loss as possible it is provided that the electrical connections are configured such that leakage currents generated are as small as possible. Furthermore, it is provided that the electrical connections such as plugs or the like are protected against dirt and moisture from the environment, so that any resulting energy losses are minimal.

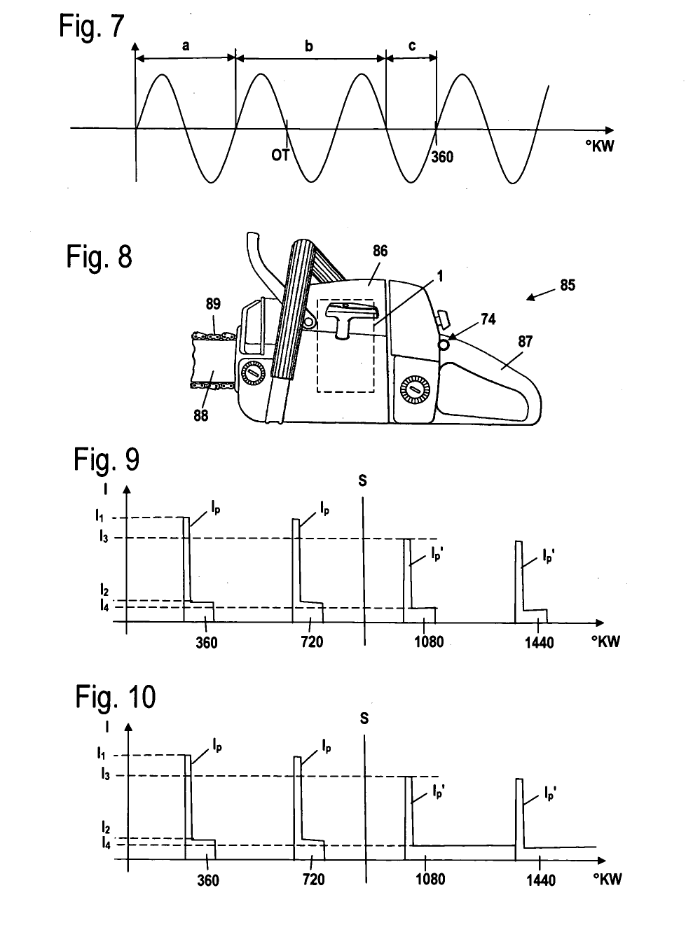

During operation, it is provided that in the case of energy generation in a generator, the induced half-waves—in the embodiment six half-waves are provided—are distributed to the individual consumers such as the ignition energy store and the energy store for the fuel valve 23. Here, for example, as is shown schematically in FIG. 7, it can be provided that the energy generated in a first section (a), which includes the first two half-waves, is used for the fuel valve 23, that the energy generated in a second section (b) is supplied to the ignition energy store, and that the energy generated in a third section (c) is used to supply the control unit 20 with energy. The location and size of the three sections (a, b, c) can be changed based on demand; for example, in dependence on the revolutions per minute, on the supplied amount of fuel which is determined via the duty cycle and via the charge state of the energy store. The duty cycle designates the ratio of the time period for which the valve is kept closed to the total time period. The amount of fuel supplied via the clocked fuel valve 23 can be set by the duty cycle.

Advantageously, the required energy is generated when the peripheral speed of the crankshaft 7 is especially high, that is during the downstroke of the piston 5 after the top dead center OT.

To control the current, a two-position controller or a PI controller, operating at a high frequency, is provided.

The shown combustion engine 1 can be used in a handheld work apparatus. As an example of this, a motor-driven chain saw 85 is shown in FIG. 8. The motor-driven chain saw 85 has a housing 86 in which the combustion engine 1 is arranged. The motor-driven chain saw 85 includes a rear handle 87. On the opposite side of the housing 86, a guide bar 88, on which a rotating saw chain 89 is arranged, projects forward. The saw chain 89 is driven by the combustion engine 1. The stop switch 74 is arranged adjacent to the rear handle 87.

FIGS. 9 to 11 show embodiments of the powering of the fuel valve 23 before and after the closing S of stop switch 74. In the embodiment according to FIG. 9, the fuel valve is powered to close at a current level I₁ via a current peak Iₚ and kept closed at a current level I₂. After the closing S of the stop switch 74, the fuel valve 23 is closed with a current level I₃, which is lower than I₁, via a current peak I_{p′}. The fuel valve 23 is subsequently kept closed at a current level I₄, which is lower than I₂. The current level I₄ can also correspond to the current level I₂. As FIG. 9 shows, the fuel valve 23 is kept closed only for a portion of a rotation of crankshaft 7, and that is in particular when there is underpressure in the intake channel 16.

In the embodiment according to FIG. 10, the powering of the fuel valve 23 during operation corresponds to the powering described in regard to FIG. 9. After the closing S of the stop switch 74, the fuel valve 23 is permanently kept closed. Thereby, only the duration of the powering at the current level I₄ until the next current peak I_{p′} is extended, so that the fuel valve 23 is powered with a current peak I_{p′} for every rotation of the crankshaft 7.

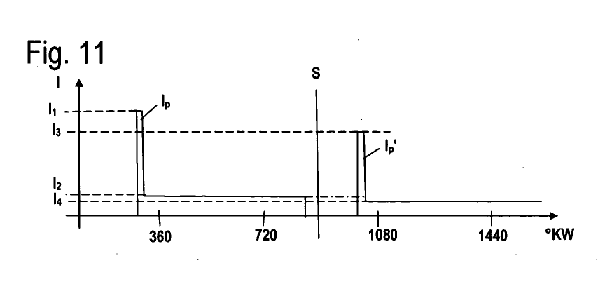

FIG. 11 shows the powering of the fuel valve 23, which represents an independent inventive idea. During operation, the fuel valve 23 in the embodiment is kept closed for close to two rotations of the crankshaft 7. For this, the fuel valve 23 is powered by a current peak Iₚ at a current level I₁ and subsequently kept closed at the current level I₂ for more than one rotation of the crankshaft 7. A further powering with a further current peak Iₚ does not take place because the fuel valve 23 is closed already. Thereby, energy can be saved. Keeping the fuel valve closed can thus take place for clearly more than two rotations of the crankshaft 7.

After the closing S of the stop switch 74, the fuel valve 23 is initially powered with a current peak I_{p′} at a current level I₃. Subsequently, the current level drops to a current level I₄. Here, too, the fuel valve 23 is kept closed for more than one rotation of the crankshaft 7. Advantageously, the fuel valve 23 is kept closed until the voltage drops below a minimum voltage Uₘᵢₙ without a further powering with a current peak Iₚ occurring.

If the stop switch 74 is closed while the fuel valve 23 is kept closed at the current level I₂, the fuel valve 23 can be kept closed continuously so that after the closing of the stop switch 74, the powering with the current peak Iₚ can also be omitted. This is schematically indicated by the broken line in FIG. 11. In this case, it can be provided that the current level drops from the current level I₂ to the current level I₄.

It is understood that the foregoing description is that of the preferred embodiments of the invention and that various changes and modifications may be made thereto without departing from the spirit and scope of the invention as defined in the appended claims.

What is claimed is:

1. A method for operating a combustion engine, said combustion engine including: a combustion chamber; a carburetor for supplying an air/fuel mixture and said carburetor having an intake channel formed therein wherein, during operation of said combustion engine, an underpressure develops drawing fuel into said intake channel; an electromagnetic fuel valve configured to be open when unpowered and to at least partially control the amount of fuel supplied to said intake channel; an ignition device for igniting said air/fuel mixture in said combustion chamber; a stop switch for switching off the ignition device; a control unit; and, an energy supply device; said method comprising the steps of:
actuating said stop switch; and,
then causing said control unit to hold the fuel valve closed.

2. The method of claim 1, wherein said fuel valve is held closed only for predetermined time intervals after said stop switch is closed.

3. The method of claim 2, wherein said fuel valve is held closed only when there is an underpressure in said intake channel.

4. The method of claim 1, comprising the further steps of closing said fuel valve during operation with a current peak (Iₚ, I_{P′}) and holding said fuel valve closed at a current level (I₂, I₄) lower than said current peak (Iₚ, I_{p′}).

5. The method of claim 1, wherein said fuel valve is closed with a lower current level (I₃, I₄) after the closing of said stop switch than during operation of said combustion engine.

6. The method of claim 1, wherein holding said fuel valve closed after said stop switch has been closed is accomplished at a lower current level (I₃, I₄) than during operation of said combustion engine.

7. The method of claim 4, wherein said combustion engine has a crankshaft; and, said fuel valve is held closed at said low current level (I₂, I₄) over more than one rotation of said crankshaft.

8. The method of claim 1, wherein said combustion engine further comprises an energy store configured for the intermediate storage of energy.

9. The method of claim 8, further comprising the step of storing energy in said energy store during operation of said combustion engine.

10. The method of claim 8, further comprising the step of storing energy in said energy store after closing said stop switch.

11. The method of claim 8, wherein said energy store holds a charge voltage (U_{lade}) and said method further comprises the steps of:
monitoring said charge voltage (U_{lade}) of said energy store after said stop switch has been closed; and,
ceasing to hold said fuel valve closed when said charge voltage U_{lade} drops below a minimum voltage (Uₘᵢₙ, Uₘᵢₙ₁, Uₘᵢₙ₂, Uₘᵢₙ₃, Uₘᵢₙ₄).

12. The method of claim 1, wherein said control unit has a microcontroller having a clock rate; and, said method further comprises the steps of:
changing said clock rate in dependence upon the operating state of said combustion engine; and,
operating said microcontroller at a low clock rate after said stop switch has been closed.

13. The method of claim 1, wherein said combustion engine rotatably drives a crankshaft; and, said method further comprises the step of:
generating energy for said ignition device, said control unit and for closing said fuel valve from the rotational movement of said crankshaft.

14. The method of claim 13, wherein said combustion engine further comprises a charging coil having several sections whereat partial voltages can be tapped; and, said method further comprises the step of inducing energy into said charging coil for charging said energy store.

15. The method of claim 1, said combustion engine further including a generator; and, said method further including generating the energy with said generator.

16. The method of claim 15, wherein said generator generates half waves; and, said method further comprises the step of distributing said half waves to consumers during operation of said combustion engine.
